(19) United States
(12) Patent Application Publication
(10) Pub. No.: US 2026/0133067 A1
(43) Pub. Date: May 14, 2026

(54) SYSTEMS, DEVICES AND METHODS FOR DEMOCRATIZING SHORTWAVE INFRARED IMAGING WITH AVALANCHING NANOPARTICLES

(71) Applicant: The Trustees of Columbia University in the City of New York, New York, NY (US)

(72) Inventors: P. JAMES SCHUCK, New York, NY (US); EMMA ZEYAN XU, New York, NY (US); CHANGHWAN LEE, New York, NY (US)

(21) Appl. No.: 18/934,975

(22) Filed: Nov. 1, 2024

Related U.S. Application Data
(60) Provisional application No. 63/595,085, filed on Nov. 1, 2023.

(51) Int. Cl. G01J 1/44

(52) U.S. Cl. CPC G01J 1/44; G01J 2001/4466

(57) ABSTRACT

Exemplary methods, systems and devices according to the exemplary embodiments of the present disclosure are provided for performing a shortwave infrared (SWIR) imaging procedure. Thus, the exemplary methods, systems and devices can apply a photon avalanching material to a substrate, and place the substrate in optical communication with a light receiving material.

### CROSS REFERENCE TO RELATED APPLICATIONS

This application relates to and claims the benefit of priority from U.S. Provisional Ser. No. 63/595,085 , filed on Nov. 1, 2023, the entire disclosure of which is incorporated herein by reference.

### FIELD OF THE DISCLOSURE

The present disclosure relates to imaging using avalanching nanoparticles, and more particularly to systems, devices and methods for democratizing shortwave infrared imaging using avalanching nanoparticles.

### BACKGROUND INFORMATION

Shortwave Infrared (SWIR) range refers to a range of wavelengths spanning roughly 1 to 2 μm. This region lies slightly beyond the wavelengths visible to the human eye. By capturing images in SWIR, valuable chemical and environmental data can be obtained for various systems that are not accessible using visible light alone. Consequently, SWIR imaging can be important in many industries, such as, e.g., semiconductor manufacturing, agriculture, and healthcare. The applications of SWIR can include, e.g., inspecting wafers, sorting food products, conducting deep tissue imaging, night vision, and numerous others.

An important component of a SWIR camera is its photodetector (PD). The PD can be made up of many pixels; they are arranged in 1D or 2D arrays. Each pixel is composed of two major parts: a photodiode layer that collects the incoming photons and subsequently converts them into electrical signals; then that signal is sent to a complimentary metal-oxide semiconductor (CMOS) readout integrated circuit (ROIC), which is coupled to the photodiode via different methods.

Indium Gallium Arsenide (InGaAs): While Silicon (Si) can be a preferred material for most semiconductor applications, it can fall short when it comes to SWIR because it is photosensitive to wavelengths only up to 1000nm. The incumbent SWIR detection technology uses InGaAs for the photodiode layer. InGaAs is a semiconductor compound engineered specifically to be sensitive in the SWIR region, with a quantum efficiency (QE) of 60-80% between 950 and 1650 nm. This high QE, coupled with a fast response time (ns), has made InGaAs the dominant SWIR detection solution on the market.

However, InGaAs also comes with several major drawbacks. For example, intrinsic to its small bandgap, which makes InGaAs photosensitive to SWIR, is higher dark current noise. Compared to a Si camera, an InGaAs camera can have dark current 6 orders of magnitude higher. A prominent method to limit this adverse effect is to cryogenically cool the InGaAs with liquid nitrogen (see, e.g., FIG. 1(a) comparing cooling and other parameters between various photodetectors for SWIR). Depending on the setup, the dark current can reach levels that are “only” 1-2 orders of magnitude higher than Si. (See, e.g., Ref. 2). The cooling requires significant power consumption and also comes at a spectral cost: as the temperature decreases, the photosensitive SWIR wavelength range shrinks. Hence, it loses the ability to detect the longer SWIR wavelengths. Another major disadvantage of InGaAs is the complicated nature of the PD fabrication. FIG. 1(b) illustrates the relative complexity of an InGaAs fabrication process as compared to other photodetector approaches. InGaAs photodiodes are produced with photolithography processes on 3-or 4-inch Indium Phosphide (InP) wafers in cleanrooms. They are then bonded to CMOS ROIC with indium (In) bumps. This process is complicated and costly; moreover, it limits the pixel size to ˜20 μm to preserve the fidelity of the pixel quality. InGaAs image sensor chips, therefore, can cost $10-20 k each, and a full camera with built-in cooling and other add-ons can cost in the $20-50 k range.

Colloidal Quantum Dots (CQDs): Previously, researchers have exploited a new design for SWIR photodiodes using CQDs, which was recently commercialized. CQDs are semiconducting nanostructures that can respond to different wavelengths by simply modifying their physical sizes. Compared to InGaAs, one major advantage of a CQD PD is its fabrication process. While ˜10 layers of CQDs, transport, and electrode layers are needed, and the patterning of the pixels still needs to be done in the cleanroom, the process can be done on a CMOS ROIC monolithically. FIG. 1(b) shows an exemplary fabrication process of CQD compared to the complexity of InGaAs. This process reduces the pixel size (down to the length of SWIR waves), hence increasing the pixel density compared to InGaAs sensors.

However, CQD cameras also come with disadvantages. Like InGaAs, CQD systems have dark current noise relative to Si and require cooling, as illustrated in FIG. 1(a). CQD systems can also have QEs much lower than those of InGaAs PDs (<15% in SWIR), limiting their performance. There are multiple reasons for this:
a. QDs have low carrier mobility
b. size uniformity of QDs can be hard to control at the atomic scale during the synthesis, directly impacting the wavelengths they absorb; and
c. QDs also are prone to degradation in air and moisture. Notably, the cost of commercially available CQD cameras remains high because of
   i. complicated fabrication,
   ii. cooling is still needed to improve the signal-to-noise ratio, and
   iii. an active illumination system is required to compensate for the low QE.
Both InGaAs and CQD have significant drawbacks for use with SWIR. Thus, there is a need to address and/or improve such drawbacks, issues and/or deficiencies which exist in the previous devices, systems, and processes.

### SUMMARY OF EXEMPLARY EMBODIMENTS

The following is intended to be a brief summary of the exemplary embodiments of the present disclosure, and is not intended to limit the scope of the exemplary embodiments.

According to the exemplary embodiments of the present disclosure, methods, systems and devices can be provided for shortwave infrared imaging by applying a photon avalanching material to a substrate and placing the substrate in optical communication with a light receiving material. The photon avalanching material can be or include a plurality of avalanching nanoparticles (ANPs) which can be Thulium-based. The light receiving material can be an imager that can be silicon-based. The substrate is capable of converting incoming SWIR light to a lower wavelength light that is detectible by the silicon-based imager. Furthermore, the wavelength conversion of the SWIR light can be caused by the photon avalanching material. This conversion can be caused by a seed excitation laser directed into the substrate, where the seed excitation laser excites the photon avalanching material to a photon avalanching threshold. The wavelength conversion of the SWIR light can occur once the photon avalanching threshold is reached. In some exemplary embodiments of the present disclosure, an energy of the seed excitation laser can be less than an energy required to reach the photon avalanching threshold. The seed excitation laser energy can be amplified by condensing the beam in one dimension and illuminating the condensed beam from a side using a cylindrical lens. Additionally, the seed excitation laser energy can be amplified with one or more mirrors on one or more sides of the substrate. The substrate can be chosen to support a target total internal reflection of the seed excitation laser.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1(a) is a table of an exemplary side-by-side comparisons between InGaAs, CQD, and ANP-enabled photodetectors across multiple performance factors according to an exemplary embodiment of the present disclosure;

FIG. 1(b) is a table of an exemplary illustration of an exemplary fabrication process of the three types of photodetectors, InGaAs, CQD, and ANP, according to an exemplary embodiment of the present disclosure;

FIG. 2(a) is a graph illustrating an exemplary absorption and emission spectrum of Tm according to an exemplary embodiment of the present disclosure;

FIG. 2(b) is an exemplary energy level diagram of Tm, where the upward arrows are the absorption in SWIR and the downward arrow is the PA emission, according to an exemplary embodiment of the present disclosure;

FIG. 3(a) is an exemplary graph illustrating emission intensity versus excitation intensity for photon avalanching according to an exemplary embodiment of the present disclosure;

FIG. 3(b) is an exemplary illustration of an exemplary SWIR detection with ANP and Si CMOS according to an exemplary embodiment of the present disclosure; and

FIG. 4 is a flow diagram of a method according to an exemplary embodiment of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENT(S)

The following description of exemplary embodiments provides non-limiting representative examples referencing numerals to particularly describe features and teachings of different aspects and exemplary embodiments of the present disclosure. The exemplary embodiments described herein should be recognized as capable of implementation separately, or in combination, with other exemplary embodiments from the description of the exemplary embodiments. A person of ordinary skill in the art reviewing the description of the exemplary embodiments should be able to learn and understand the different described aspects of the present disclosure. The description of the exemplary embodiments should facilitate understanding of the invention to such an extent that other implementations, not specifically covered but within the knowledge of a person of skill in the art having read the description of embodiments, would be understood to be consistent with an application of the exemplary embodiments of the present disclosure.

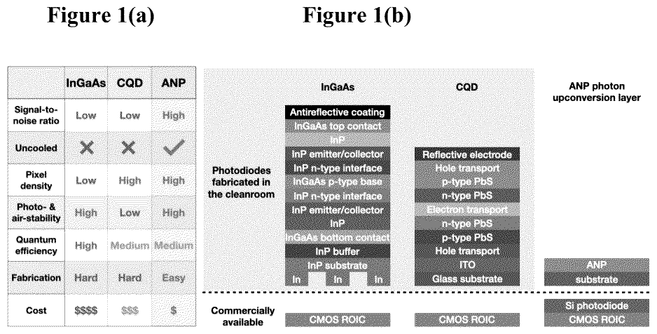

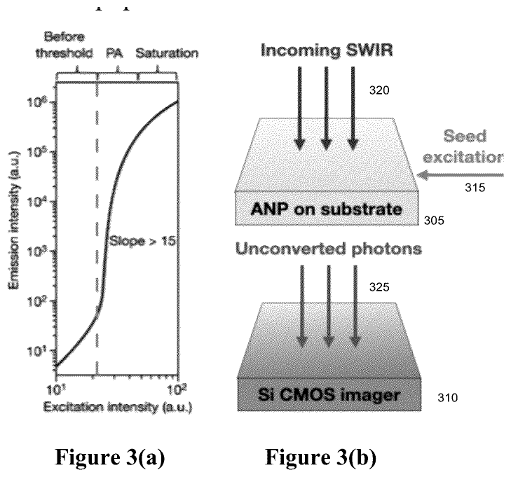

Avalanching Nanoparticles (ANPs): ANPs are nanocrystals that exhibit exceptional photon upconversion (UC) and photon avalanching (PA) properties. Photon avalanching is distinct from the electron-avalanching process, which occurs in some semiconductor systems and is utilized in several common photodetector devices (for example, so-called avalanching photodiodes (APDs)). Photodetectors utilizing electron avalanching can still only detect wavelengths that are absorbed by the semiconductor. Hence, Si-based photodetectors that support electron avalanching cannot detect SWIR wavelengths. With photon UC, ANPs can convert SWIR wavelengths between 1 and 2 μm into wavelengths detectable by Si (<1 μm). With PA, ANPs can dramatically increase the efficiency of the UC process, from approximately 1% up to around 40%. (See, e.g., Ref. 5). This improvement in QE makes ANPs a serious contender in SWIR imaging. There are several other competitive advantages of ANPs. FIG. 1(a) highlights the performance advantages of ANPs over other photodetectors. For example:
I. Compared to its colloidal counterpart CQD, the synthesis of ANPs is highly uniform, and the ANPs have exceptional air-and photo-stability over long periods of time (years).
II. Instead of providing a completely new PD device, it is possible to simply couple ANPs to a commercially available Si CMOS imager (e.g., Si photodiode & CMOS ROIC in one product, as illustrated in FIG. 1(b) and 3(b)). The benefit of leveraging Si imagers can be as follows:
   i. Easy fabrication: ANPs can simply be spin-coated or drop-casted onto a substrate. This is in contrast to both InGaAs (see, e.g., Ref. 3) and CQD (see, e.g., Ref. 4) photodiodes, which need to be fabricated in a cleanroom;
   ii. Low cost: the cost of ANPs for the amount needed is negligible, and the Si imagers are very affordable compared to InGaAs (˜$100);
   iii. low noise without cooling: Si is an inherently low-noise system (due to a larger bandgap than InGaAs and SWIR CQDs), so no cooling is required to achieve the low-noise level, which the other two systems cannot approach, even with cooling;
   iv. Saturation resistant: in low-light conditions when longer integration times are needed, the best InGaAs cameras saturate with dark noise after 2 minutes, while CMOS cameras can go for many hours; and
   v. Reliability: high-quality pixels and high pixel density have already been perfected over the decades of R&D efforts poured into Si semiconductor development.
According to exemplary systems, methods and devices according to the exemplary embodiments of the present disclosure, it is possible to provide an ANP-enabled SWIR camera. Unlike previous research on SWIR imaging that makes incremental advancements in InGaAs and CQD systems, according to the exemplary embodiments of the present disclosure, the exemplary systems, methods, and devices can combine efficient photon upconversion and Si-based imagers to achieve an affordable and highly functional SWIR imaging system, as illustrated in FIG. 1(a), 1(b), 3(a) and 3(b).

With the exemplary systems, methods and devices according to the exemplary embodiments of the present disclosure, the utilization of ANPs for technological applications can be improved, and effectuate the use of photon avalanching nanomaterials (and photon upconversion technology in general) for SWIR detection and imaging.

Moreover, there is a high demand for affordable SWIR cameras, both commercially and scientifically. ANP-enabled SWIR cameras of exemplary systems, methods and devices according to the exemplary embodiments of the present disclosure can provide affordability without compromising on performance. For example, by efficiently converting SWIR into Si-detectable wavelengths, exemplary systems, methods and devices according to the exemplary embodiments of the present disclosure can utilize the benefits of Si CMOS imagers, and access certain performance factors that are superior to the InGaAs and CQD counterparts. Such benefits can include, e.g.: significantly lower noise; no cooling needed; saturation resistant, high-quality pixels; and high pixel density (high resolution). These exemplary properties can render ANP-enabled SWIR cameras of exemplary systems, methods and devices according to the exemplary embodiments of the present disclosure advantageous for many applications, including but not limited to silicon wafer inspection, plastic and glass sorting, defense and surveillance, etc.

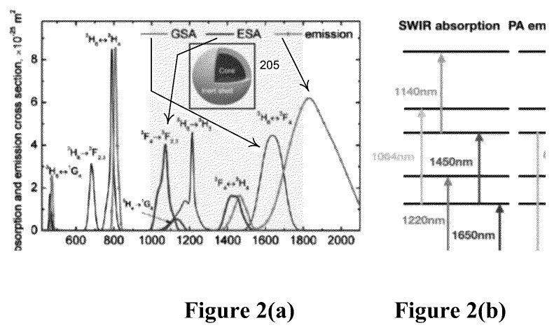

ANPs are nano-particles doped with rare-earth elements. The most common host matrix is, e.g., NaYF₄. Several elements have been identified to exhibit the PA behavior and can all be beneficial for SWIR detection. According to the exemplary embodiments of the present disclosure, one exemplary application is the use of Thulium (Tm)-based ANPs, since they have absorption peaks covering most of the SWIR band. FIG. 2(a), for example, shows a graph of an exemplary absorption and emission spectrum of Tm, especially in the SWIR band, where as shown in FIG. 2(a), GSA is the ground state absorption, ESA is the excited state absorption, and the shaded area corresponds to SWIR wavelengths ranging from 1-1.8 μm. Further, element 205 in FIG. 2(a) is illustrated as the core-shell structure of the ANP.

With the exemplary systems, methods and devices according to the exemplary embodiments of the present disclosure, during PA, a population inversion can be created at the excited state. For example, the number of lanthanide ions (such as Tm) within the nanoparticle in an excited state can exceed that in the ground state. This phenomenon is responsible for the bright emission and the high QE of ANPs. To facilitate specific absorption peaks, as illustrated in FIG. 2(a), to benefit from PA, the exemplary systems, methods and devices according to the exemplary embodiments of the present disclosure can provide and/or utilize a seed excitation at the PA threshold intensity of the ANPs. For example, FIG. 3(a) illustrates an exemplary graph with an exemplary s-shaped, high-slope curve of PA, where the dotted line is indicative of the PA threshold intensity. The exemplary threshold intensity can be on the order of a few kW/cm²; this can be achieved with standard IR laser diodes (e.g., ˜100 mW) and sheet illumination techniques. Moreover, the seed excitation can also accelerate the detection process. ANPs can have a long rise time, on the order of a few hundred milliseconds, to achieve population inversion. The introduction of the seed can shrink that time to less than 50 ms (see, e.g., Ref. 5), rendering them suitable for imaging applications. There is viability of the seed approach, which has been performed according to the exemplary systems, methods and devices of the present disclosure, e.g., measuring >100× enhancement in SWIR detection sensitivity.

The exemplary systems, devices and methods according to the exemplary embodiments of the present disclosure can utilize the exemplary ANP-enabled SWIR imager, as shown in FIG. 3(b). For example, such exemplary imager can include a substrate with a deposited ANP film 305, which is mechanically fixed above a Si imager 310 in close proximity, e.g., with both elements having the same area or substantially the same area. A seed excitation laser beam 315 (e.g., 1450 nm) can enter the substrate (e.g., from the side); this can be guided via total internal reflection (TIR). The ANP layer thus can be excited to its PA threshold. Due to their high nonlinearity, when seeded, the ANPs of the exemplary systems, devices and methods according to the exemplary embodiments of the present disclosure can be very sensitive to even a very small amount of incoming SWIR photons 320. Upon receiving an external SWIR illumination 320, the ANPs can immediately absorb those photons and emit, e.g., 800 nm light 325 detectable by the Si imager. This exemplary seeding approach, according to the exemplary embodiments of the present disclosure, can improve and/or upgrade a previously-slow multiphoton process (non-linear) into an efficient single-photon (linear) process as existed in the prior art.

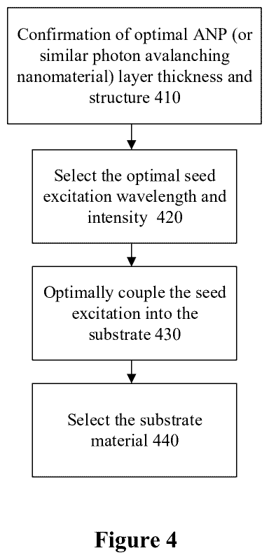

Exemplary systems, devices and methods according to the exemplary embodiments of the present disclosure can facilitate and/or implement the following determinations, as illustrated in an exemplary flow diagram of FIG. 4:
Confirmation of optimal ANP (or similar photon avalanching nanomaterial) layer thickness and structure (procedure 410). By reviewing ANP layer thickness and uniformity, exemplary systems, devices and methods according to the exemplary embodiments of the present disclosure can optimize for high absorption of the incoming SWIR photons, low scattering of the upconverted photons as they travel through the layer to the Si imager, and waveguiding properties of the seed illumination. This can be performed by iteratively varying deposition parameters and performing spatially resolved characterization measurements (e.g., atomic force microscopy, optical absorption measurements) across the layer area (e.g., 0.25-1 cm²).

Select the optimal seed excitation wavelength and intensity (procedure 420). There are a number of seed wavelengths that lead to PA, such as, e.g., about 1064 nm and 1450 nm, as well as a number of others. The exemplary systems, devices and methods according to the exemplary embodiments of the present disclosure can utilize a wavelength of about 1450 nm since this wavelength is transparent to Si, and thus cannot contribute any background noise. TIR conditions and the distance of the substrate to the Si imager can be reviewed with the exemplary systems, devices and methods according to the exemplary embodiments of the present disclosure to minimize or reduce noise.

Optimally couple the seed excitation into the substrate (procedure 430). A challenge of establishing a critical power density of the seed excitation as it enters the substrate can be addressed with the exemplary embodiments of the present disclosure. For example, with the exemplary systems, devices and methods according to the exemplary embodiments of the present disclosure, a laser diode (e.g., 100mW diode laser) can be employed, with a beam size of 10 mm 2 matched to the PD area, which can have a power density of only about 1 W/cm², which is well below the PA threshold. Exemplary systems, devices and methods according to the exemplary embodiments of the present disclosure can address and/or overcome this issue by condensing the beam in one dimension and illuminating it from the side using a cylindrical lens to achieve light sheet illumination. (See, e.g., Ref. 6). This exemplary technique can result in power densities of, e.g., 1-10 kW/cm² that can reach the PA threshold intensity. If further enhancement is required, the addition of mirrors on the sides of the substrate can be utilized (as well as other exemplary configurations), which can create an optical cavity, as can the addition of other resonator structures such as metal surfaces.

Select the substrate material (procedure 440). The substrate is important because it can be useful for supporting TIR of the seed illumination. With the exemplary systems, devices and methods according to the exemplary embodiments of the present disclosure, it can be possible to utilize transparent materials with different (e.g., wavelength-dependent) refractive indices (RI), ranging from, e.g., silica glass (RI=1.45) and quartz (RI=1.55), to dense optical flint glass (RI=1.65) or even transition metal dichalcogenides (RI=4 or greater).

In this description, numerous specific details have been set forth. It is to be understood, however, that implementations of the disclosed technology can be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one exemplary embodiment,” or “in one implementation” does not necessarily refer to the same example, exemplary embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the paragraphs, and may include other examples that occur to those skilled in the art. Such other examples are intended to be within the scope of the paragraphs if they have structural elements that do not differ from the literal language of the claims, or if they include equivalent structural elements with insubstantial differences from the literal language of the paragraphs.

### EXEMPLARY REFERENCES

The following references are hereby incorporated by references, in their entireties:
1. Peterka, P., et al., Theoretical modeling of fiber laser at 810 nm based on thulium-doped silica fibers with enhanced 3H4 level lifetime. Optics express, 2011. 19: p. 2773-81.
2. Instruments, T. P. Introduction to Scientific InGaAs FPA Cameras. July 12, 2023]; Available from: https://www.princetoninstruments.com/learn/swir-nirii/intro-to-scientific-ingaas-fpa-cameras.
3. Wang, Z. and W. E. Nuri, InP/InGaAS Symmetric Gain Optoelectronic Mixers, in Optoelectronics, L. P. Sergei and M. B. John, Editors. 2013, IntechOpen: Rijeka. p. Ch. 4.
4. Vladimir, P., et al. Switchable dual-band photodetector based on PbS colloidal quantum dots for multispectral short-wavelength infrared imaging. in Proc.SPIE. 2021.
5. Lee, C., et al., Giant nonlinear optical responses from photon-avalanching nanoparticles. Nature, 2021. 589(7841): p. 230-235.
6. Stelzer, E. H. K., et al., Light sheet fluorescence microscopy. Nature Reviews Methods Primers, 2021. 1(1): p. 73.

What is claimed is:

1. A method for performing a shortwave infrared (SWIR) imaging procedure, comprising:
applying a photon avalanching material to a substrate; and
placing the substrate in optical communication with a light receiving material.

2. The method of claim 1, wherein the light receiving material is an imager.

3. The method of claim 2, wherein the imager is a silicon-based imager.

4. The method of claim 3, wherein the substrate converts an incoming SWIR light to a lower wavelength light that is detectible by the silicon-based imager.

5. The method of claim 4, wherein the wavelength conversion of the incoming SWIR light is caused by the photon avalanching material.

6. The method of claim 5, further comprising directing a seed excitation laser beam into the substrate.

7. The method of claim 6, wherein the seed excitation laser beam excites the photon avalanching material to a photon avalanching threshold.

8. The method of claim 7, wherein the wavelength conversion of the SWIR light occurs when the photon avalanching threshold is reached.

9. The method of claim 8, wherein an energy of the seed excitation laser is less than an energy required to reach the photon avalanching threshold.

10. The method of claim 9, further comprising amplifying the seed excitation laser energy by:
condensing the seed excitation laser beam in one dimension to become a condensed beam;
and
illuminating the condensed beam from a side using a cylindrical lens.

11. The method of claim 9, further comprising amplifying the seed excitation laser energy using one or more mirrors on one or more sides of the substrate.

12. The method of claim 7, wherein the substrate is configured to support a target total internal reflection of the seed excitation laser.

13. The method of claim 1, wherein the photon avalanching material includes a plurality of avalanching nanoparticles (ANPs).

14. The method of claim 13, wherein the ANPs are Thulium-based.

15. A system for performing shortwave infrared (SWIR) imaging procedure, comprising:
a substrate including a photon avalanching material layer; and
a light receiving material in optical communication with the substrate.

16. The system of claim 15, wherein the light receiving material is an imager.

17. The system of claim 16, wherein the imager is a silicon-based imager.

18. The system of claim 17, wherein the substrate is configured to convert an incoming SWIR light to a lower wavelength light that is detectible by the silicon-based imager.

19. The system of claim 18, wherein the wavelength conversion of the SWIR light is caused by the photon avalanching material.

20. The system of claim 19, wherein the substrate receives a seed excitation laser beam.

21. The system of claim 20, wherein the seed excitation laser beam excites the photon avalanching material to a photon avalanching threshold.

22. The system of claim 21, wherein the wavelength conversion of the SWIR light occurs when the photon avalanching threshold is reached.

23. The system of claim 22, wherein an energy of the seed excitation laser is less than an energy required to reach the photon avalanching threshold.

24. The system of claim 23, wherein the seed excitation laser energy is amplified by:
condensing the seed excitation laser beam in one dimension to become a condensed beam;
and
illuminating the condensed beam from a side using a cylindrical lens.

25. The system of claim 24, wherein the seed excitation laser energy is amplified with one or more mirrors on one or more sides of the substrate.

26. The system of claim 21, wherein the substrate is configured to support a target total internal reflection of the seed excitation laser.

27. The system of claim 15, wherein the photon avalanching material is a plurality of avalanching nanoparticles (ANPs).

28. The system of claim 27, wherein the ANPs are Thulium-based.

29. A shortwave infrared (SWIR) imager, comprising:
a substrate including a photon avalanching material layer; and
a light receiving material in optical communication with the substrate.

30. The SWIR imager of claim 29, wherein the light receiving material is a photodetector.
